(19) United States
(12) Patent Application Publication
(10) Pub. No.: US 2019/0234634 A1
(43) Pub. Date: Aug. 1, 2019

(54) SYSTEMS AND METHODS FOR DETERMINING CHARACTERISTICS OF AN AMBIENT ENVIRONMENT

(71) Applicant: HONEYWELL INTERNATIONAL INC., Morris Plains, NJ (US)

(72) Inventor: Cui DU, Morris Plains, NJ (US)

(21) Appl. No.: 16/336,951

(22) PCT Filed: Sep. 25, 2017
(86) PCT No.: PCT/US17/53211

§ 371 Date: Mar. 27, 2019

(30) Foreign Application Priority Data
Sep. 30, 2016 (CN) 201611036264.8

(51) Int. Cl. F24F 11/30; F24F 11/52; F24F 11/58; F24F 11/65; F24F 11/70; G05B 19/042; G08C 17/02

(52) U.S. Cl. CPC F24F 11/30; F24F 11/52; F24F 11/58; F24F 2110/10; F24F 11/70; G05B 19/042; G08C 17/02; F24F 11/65

(57) ABSTRACT

Embodiments relate generally to systems and methods for determining one or more characteristics of the ambient air of an environment. A system may comprise a sensor device comprising a sensor housing having a circular exterior front surface; a dot matrix display incorporated into the front surface; a touch sensitive surface incorporated into the front surface; a first sensor positioned behind the front surface, configured to make measurements used for a calculation of a characteristic of ambient air; an angled bottom surface configured to rest on a horizontal surface; and a processing system programmed to detect at least one characteristic of the ambient air, and to display the detected characteristic using the dot matrix display.

### CROSS-REFERENCE TO RELATED APPLICATIONS

The present application claims priority to China Patent Application No. 201611036264.8 filed Sep. 30, 2016 by Cui Du and entitled “Systems And Methods For Determining Characteristics Of An Ambient Environment” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A variety of sensors may be employed to determine characteristics of ambient air around the sensors. The sensors may be enclosed in a housing and placed in a location where it is desired by a user to know certain characteristics of the ambient air, such as temperature, humidity, air content (such as particulate matter and/or gases), as well as other information.

### SUMMARY

In an embodiment, a sensor device may comprise a sensor housing having a circular exterior front surface; a dot matrix display incorporated into the front surface; a touch sensitive surface incorporated into the front surface; a first sensor positioned behind the front surface, configured to make measurements used for a calculation of a characteristic of ambient air; an angled bottom surface configured to rest on a horizontal surface; and a processing system programmed to detect at least one characteristic of the ambient air, and to display the detected characteristic using the dot matrix display.

In an embodiment, a method for determining one or more characteristics of the ambient air of an environment may comprise activating a sensor device comprising one or more sensors and a display; detecting, by the one or more sensors, one or more characteristics of ambient air; displaying, by a processing system via the display, the detected characteristic(s) of the ambient air; and indicating, by the processing system via the display, a health level of the detected characteristic(s).

In an embodiment, a sensor device for controlling an Heating, Ventilation and Air Conditioning (HVAC) system within an enclosure may comprise a first sensor positioned behind a front surface of the sensor device, configured to make measurements used for a calculation of a characteristic of ambient air within the enclosure; and a wireless communication system having active and inactive states, the system consuming less energy in the inactive state than in the active state, configured to communicate with the HVAC system based on the input from the first sensor, wherein the transition.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a sensor device mounted on a wall according to an embodiment.

FIG. 2 illustrates a sensor device resting on a surface according to an embodiment.

FIGS. 3A-3B illustrate different displays of the sensor device according to an embodiment.

FIGS. 4A-4E illustrate different displays of the sensor device according to one or more embodiments.

FIG. 5 illustrates a back view of the sensor device according to an embodiment.

FIG. 6 illustrates a front view of the sensor device according to an embodiment.

FIG. 7 illustrates another view of the sensor device according to an embodiment.

FIGS. 8A-8D illustrate additional views of the sensor device according to an embodiment.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field; and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Embodiments of the disclosure include methods and systems for determining characteristics of an ambient environment. Embodiments may include a sensor device that is configured to be mounted on a wall, and/or to be rested on a horizontal surface. In designing a wall-mounted or surface-mounted sensor device, it may be desirable to have a device that has a visually pleasing, smooth, sleek and rounded exterior appearance while at the same time including one or more sensors for detecting characteristics of the ambient air.

In certain areas of the world, residents may be concerned with the air quality around them, in their homes and workplaces, as well as outside.

Air quality sensors may be installed in homes or other buildings, but it also may be desirable for a user to have a portable sensor device that may be mounted on the wall and/or carried with them to different areas. A smaller device may be easier to relocate as needed. The device may comprise one or more sensors as well as a display configured to communicate the sensor information to the user. The display could also communicate other information, such as the time, weather, or any other information that may be collected by or communicated to the sensor device.

The sensor device may comprise indicators, such as lights, speakers, etc. configured to communicate information to the user. For example, different colored lights may indicate the quality of the ambient air, such as if the air quality is considered “healthy” or not. In some embodiments, the sensor device may be incorporated into a smart home system, where the sensor device may be configured to (wirelessly) communicate with a number of other devices. In some embodiments, the sensor device may comprise a voice recognition system, wherein a user may interact with the sensor device using their voice.

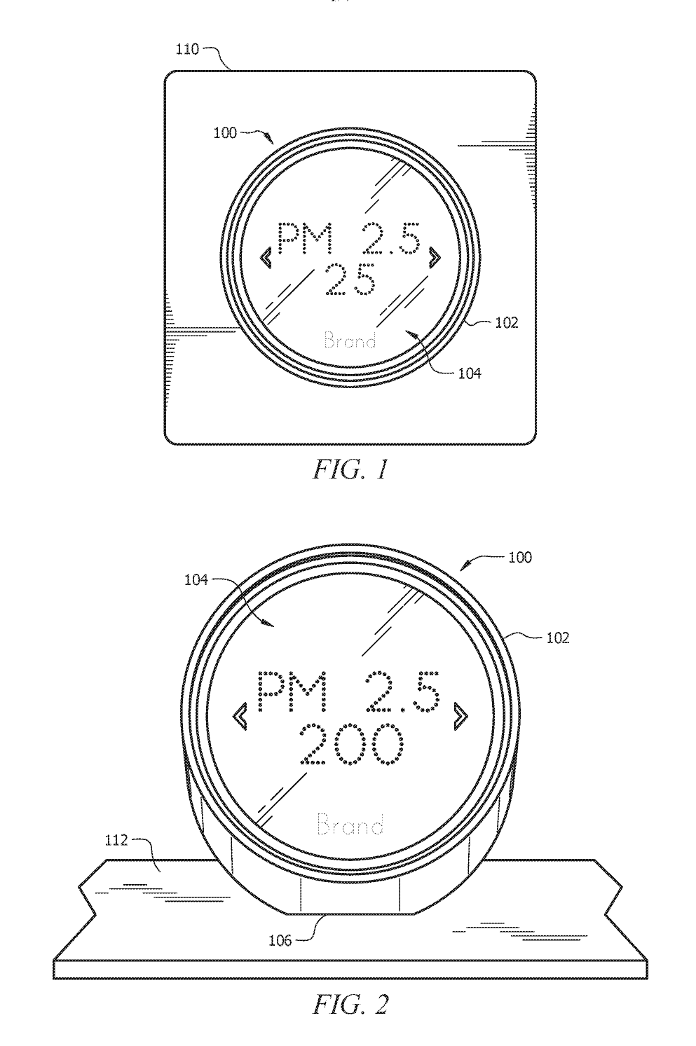

FIG. 1 illustrates a sensor device 100 having a visually pleasing, smooth, sleek and rounded exterior appearance while at the same time including one or more sensors for detecting characteristics of the ambient air, according to some embodiments. The sensor device 100 has a sleek, simple, uncluttered and elegant design that does not detract from home decoration, and can serve as a visually pleasing centerpiece for the immediate location in which it is installed. Moreover, user interaction with sensor device 100 is facilitated and greatly enhanced over known conventional thermostats by the design of the sensor device 100. The sensor device 100 includes control circuitry and may optionally be electrically connected to (or in communication with) an HVAC system. The sensor device 100 may in some embodiments be wall mountable, and may be circular in shape.

The sensor device 100 is circular in shape in that it appears as a generally disk-like circular object when mounted on the wall, as shown in FIG. 1. In some embodiments, the sensor device 100 may be configured to removably attach to a wall plate 110. In some embodiments, the sensor device 100 may comprise a rounded, or circular shaped front surface 104 and a circular shaped housing 102.

In some embodiments, for ease of installation, configuration and/or upgrading, especially by a non-expert installer such as a user, the sensor device 100 includes a housing 102 and a wall plate 110. At least a portion of the housing 102 of the sensor device 100 may be slidably mountable onto the wall plate 110 and slidably detachable therefrom. According to some embodiments the connection of the housing 102 to the wall plate 110 can be accomplished using magnets, bayonet, latches and catches, tabs or ribs with matching indentations, or simply friction on mating portions of the housing 102 and wall plate 110.

Referring to FIG. 2, the sensor device 100 is shown resting on a horizontal surface 112 such as a table, desk, counter, etc. The sensor device 100 may comprise an angled bottom surface 106 configured to allow the sensor device 100 to rest on the horizontal surface 112. In some embodiments, the sensor device 100 may be interchangeably attached to a wall plate 110 (as shown in FIG. 1) and resting on a horizontal surface 112 (as shown in FIG. 2).

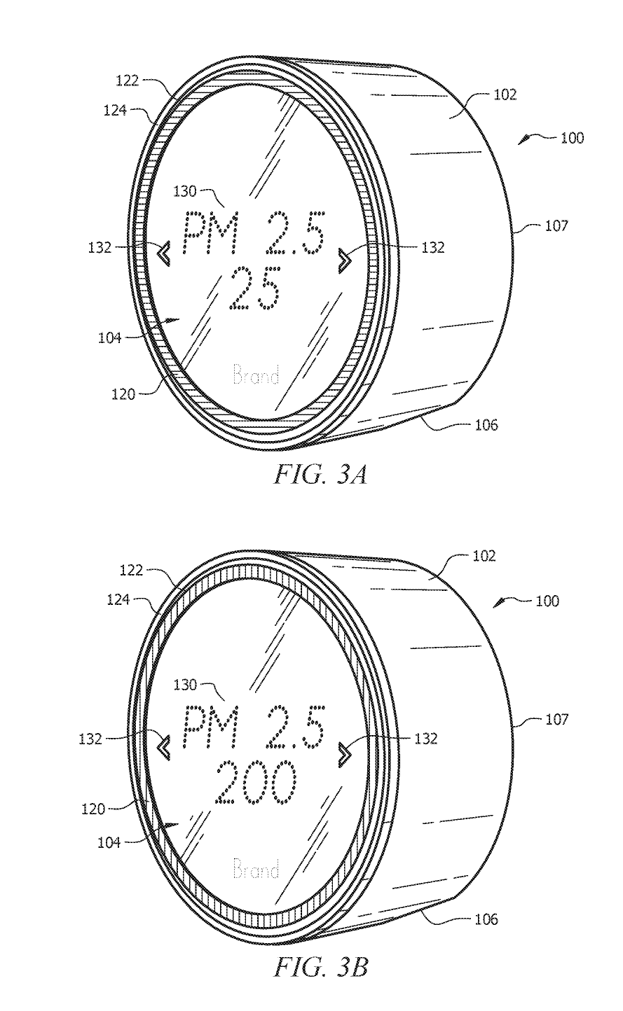

Referring now to FIGS. 3A-3B, the sensor device 100 may comprise a circular shaped housing 102 (as described above), wherein the angled bottom surface 106 may be incorporated into the housing 102. The housing 102 may also comprise a back surface 107. In some embodiments, the front surface 104 of the sensor device 100 may comprise a dot matrix display 130. Additionally, the front surface 104 may comprise one or more touch sensitive surfaces 132. The touch sensitive surface 132 allows the user to make adjustments, such as selecting a new set-point temperature, switching between different displays, inputting alarm or other indication settings, etc. in some embodiments, the touch sensitive surface 132 may comprise one or more buttons configured to receive input from a user. In some embodiments, the touch sensitive surface 132 may comprise a portion of the display 130 of the front surface 104.

The front surface 104 of the sensor device 100 may comprises a clear material that, in some embodiments, may comprise polycarbonate, glass, or another similar material. According to some embodiments, the sensor device 100 may comprise a microphone 122 and/or a speaker 124 located within the housing 102. In some embodiments, the microphone 122 and/or speaker 124 may be located near the front surface 104 of the sensor device 100.

In some embodiments, the central electronic display 130 may comprise a dot-matrix layout (i.e. individually addressable) such that arbitrary shapes can be generated, rather than being a segmented layout. According to some embodiments, a combination of dot-matrix layout and segmented layout is employed. In some embodiments, the display 130 may comprise a backlit color liquid crystal display (LCD). In some embodiments, the display 130 may be incorporated into the front surface 104, while in other embodiments the display 130 may be located behind the front surface 104.

In some embodiments, the sensor device 100 may comprise one or more indicator lights 120 located within the front surface 104. In the embodiment shown in FIGS. 3A-3B, the indicator light 120 may be located around the perimeter of the front surface 104. The indicator light 120 may be utilized to indicate the health or quality of the current ambient air characteristics. For example, in FIG. 3A the Particulate Matter (PM) 2.5 reading may be approximately 25 micrograms per cubic meter (μg/m³), which may be within a “healthy” range for that reading. Therefore, the processor of the sensor device 100 may activate the indicator light 120 to be a “healthy” color.

Then, in FIG. 3B, the PM 2.5 reading is approximately 200 μg/m³ which may be within an “unhealthy” range for that reading. In some embodiments, the reading in FIG. 3B may be higher than an acceptable threshold, where the threshold may be programmed into the sensor device 100. Therefore, the processor of the sensor device 100 may activate the indicator light 120 to be an “unhealthy” color, which may be different from the “healthy” color. In some embodiments, the processor may activate an alert or alarm when the PM 2.5 reading is higher than the acceptable threshold.

The indicator light 120 may also indicate healthy, high, or low temperature, healthy or high CO₂ levels, healthy, high, or low humidity levels, among other similar indications. The indicator light 120 may comprise one color that indicates healthy characteristics (such as blue or green) and a second color that indicates unhealthy characteristics (such as orange or red). In some embodiment, the indicator light 120 may comprise more than two colors, where each color may indicate a different level or range.

In some embodiments, the color of the indicator light 120 may change when a user switches the display 130 between different displays that show the outputs from different sensors. For example, a first sensor may be configured to detect a first characteristic, where the first characteristic may be associated with a first set of predefined thresholds. Similarly, a second sensor may be configured to detect a second characteristic, where the second characteristic may be associated with a second set of predefined thresholds. When the display is switched from the first characteristic to the second characteristic, the indicator light may change according to the predefined thresholds.

In some embodiments, the sensor device 100 may be configured to communicate with an HVAC system. In some embodiments, the sensor device 100 may be configured to wirelessly communicate with an HVAC system.

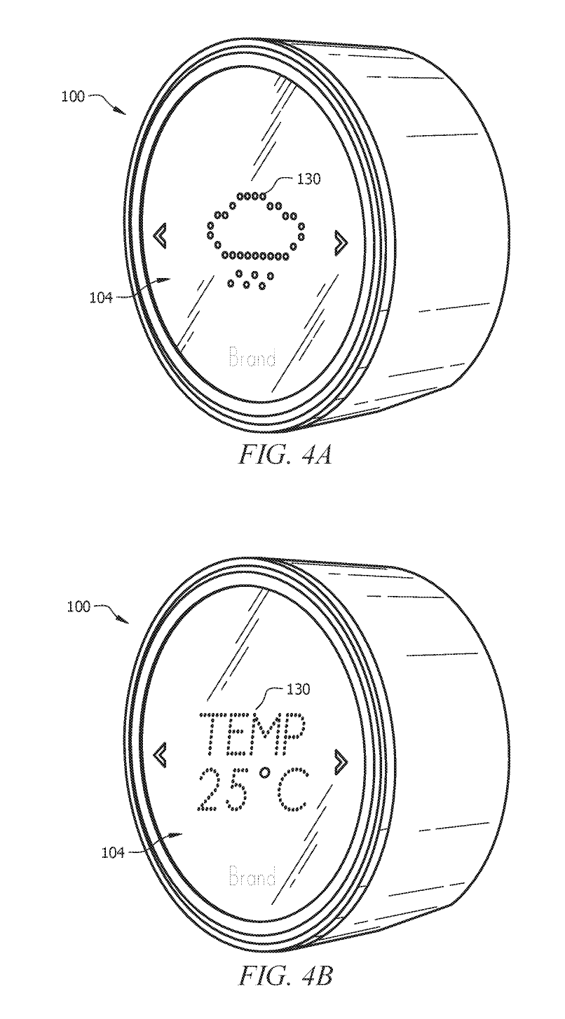

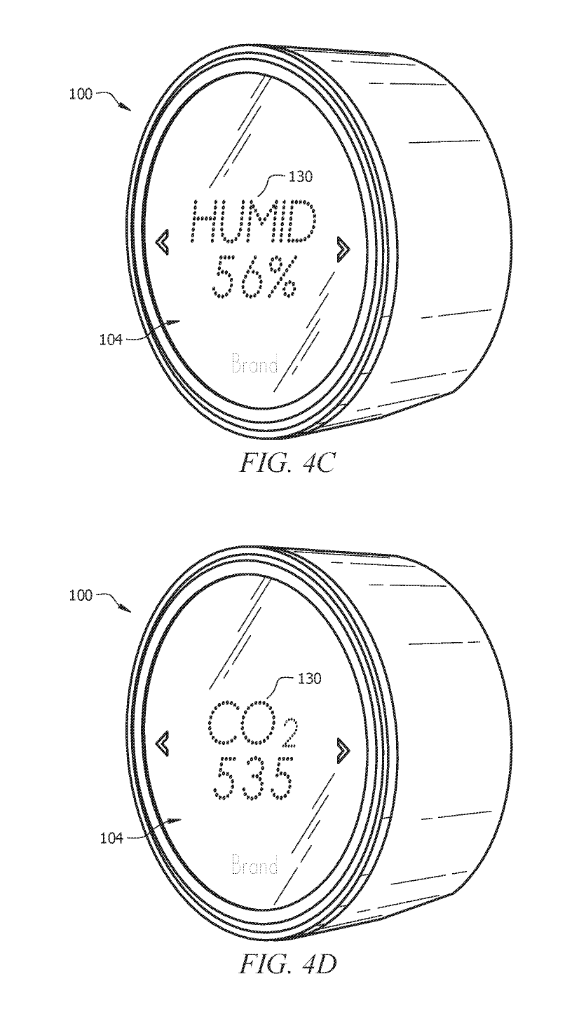

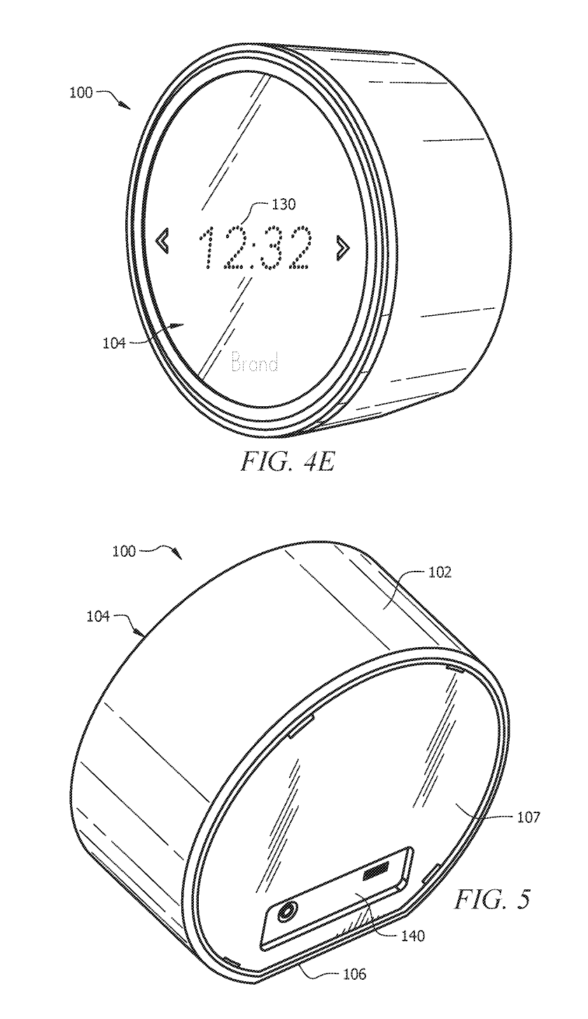

A plurality of images may be shown by the display 130 when a user taps or presses the touch sensitive surface 132. The display 130 may include numerals, shapes, words, and/or letters that are representative of the current detected characteristic, such as air quality (or more specifically PM 2.5 readings), gas levels, temperature, humidity, or other weather information. Additional examples of displays are shown in FIGS. 4A-4E.

FIG. 4A illustrates another view of the sensor device 100, where the display 130 is indicating the current weather.

FIG. 4B illustrates another view of the sensor device 100, where the display 130 is indicating the current temperature.

FIG. 4C illustrates another view of the sensor device 100, where the display 130 is indicating the current humidity.

FIG. 4D illustrates another view of the sensor device 100, where the display 130 is indicating the current CO₂ level.

FIG. 4E illustrates another view of the sensor device 100, where the display 130 is indicating the current time.

Referring to FIG. 5 the back surface 107 of the sensor device 100 is shown. The back surface 107 may be configured to attach to a wall plate 110 (as described above). The back surface 107 may comprise one or more connectors 140, wherein the connectors 140 may comprise power connectors, Ethernet ports, Universal Serial Bus (USB) ports, audio ports, or any other similar port or connector.

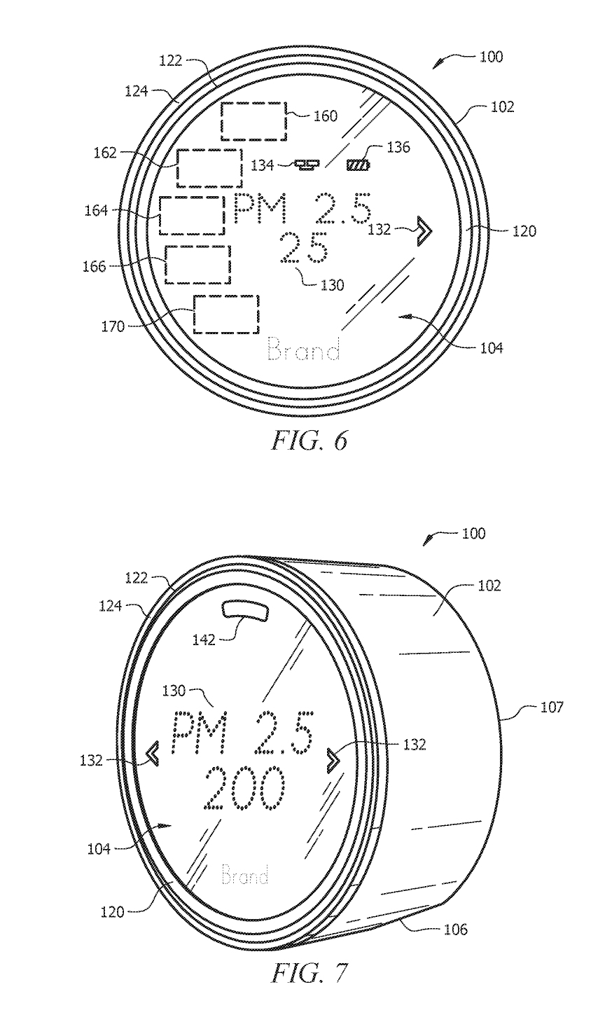

Referring to FIG. 6, a front view of the sensor device 100 is shown. In some embodiments, the display 130 may comprise additional indicators, such as a wireless connection indicator 134 and/or a battery indicator 136. One or more sensors 170 (as described above) may be located within the housing 102 of the sensor device 100. In some embodiments, the sensor device 100 includes a processing system 160, display driver 164 and a wireless communications system 166. The processing system 160 may be adapted to cause the display driver 164 and display 130 to display information to the user, and to receive user input via the touch sensitive surface(s) 132. The processing system 160 may be capable of carrying out the governance of the operation of the sensor device 100 including various user interface features. The processing system 160 may be further programmed and configured to carry out other operations as described herein.

According to some embodiments, the wireless communications system 166 may be used to communicate with devices such as personal computers and/or other sensor devices or HVAC system components, which can be peer-to-peer communications, communications through one or more servers located on a private network, and/or communications through a cloud-based service.

Also shown in FIG. 6 is a rechargeable battery 162 that may recharged using recharging circuitry that uses power from the wall plate 110 (shown in FIG. 1), or a power connector 140 in the back surface 107 (shown in FIG. 5). According to some embodiments, the rechargeable battery 162 is a single cell lithium-ion, or a lithium-polymer battery.

FIG. 7 illustrates an embodiment of the sensor device 100, wherein the sensor device 100 further comprises one or more sensors 142 incorporated into the front surface 104. The sensor(s) 142 may comprise light sensors (which may inform the brightness of the display 130), proximity sensors, IR sensors, or other similar sensors.

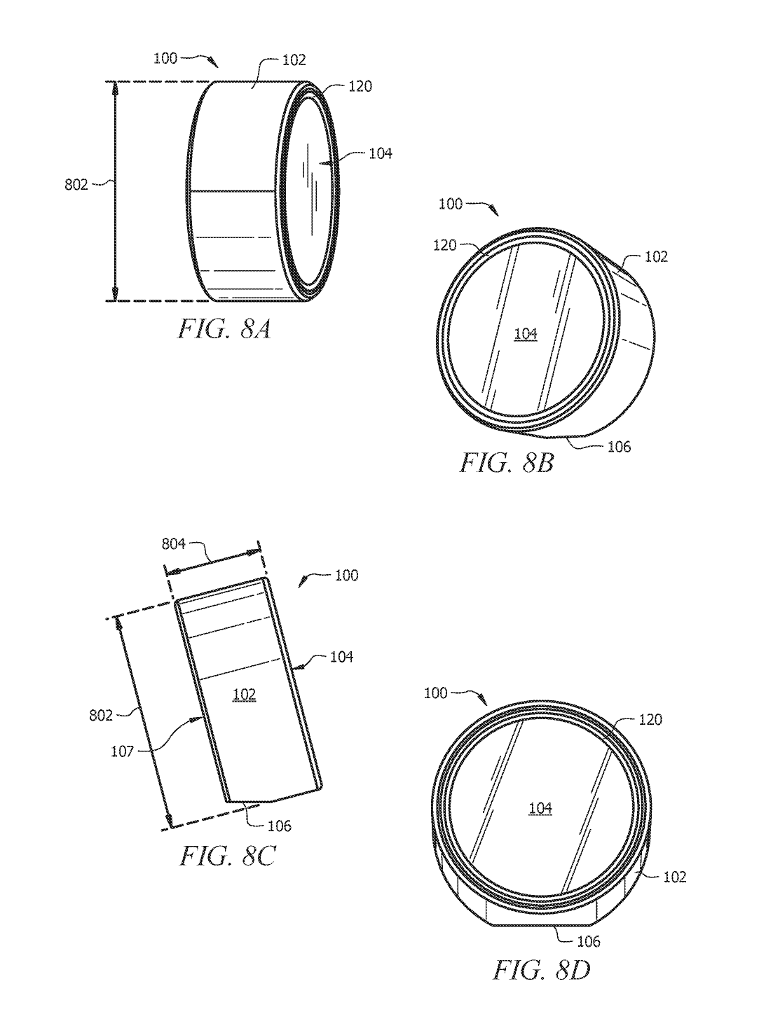

FIGS. 8A-8D illustrate a plurality of views of the sensor device 100. In some embodiments, the sensor device 100 may comprise a height 802 (or diameter) of approximately 96 mm. In some embodiments, the sensor device 100 may comprise a height 802 (or diameter) less than approximately 100 mm. In some embodiments, the sensor device 100 may comprise a height 802 (or diameter) less than approximately 150 mm. In some embodiments, the sensor device 100 may comprise a depth 804 (or thickness) of approximately 45 mm. In some embodiments, the sensor device 100 may comprise a depth 804 (or thickness) of less than approximately 50 mm.

In a first embodiment, a sensor device may comprise a sensor housing having a circular exterior front surface; a dot matrix display incorporated into the front surface; a touch sensitive surface incorporated into the front surface; a first sensor positioned behind the front surface, configured to make measurements used for a calculation of a characteristic of ambient air; an angled bottom surface configured to rest on a horizontal surface; and a processing system programmed to detect at least one characteristic of the ambient air, and to display the detected characteristic using the dot matrix display.

A second embodiment can include the sensor of the first embodiment, wherein the touch sensitive surface comprises one or more buttons incorporated into the front surface.

A third embodiment can include the sensor of the first or second embodiments, wherein the touch sensitive surface comprises at least a portion of the front surface.

A fourth embodiment can include the sensor of any of the first to third embodiments, wherein the first sensor comprises at least one of a temperature sensor, a particulate matter sensor, a humidity sensor, or a gas sensor.

A fifth embodiment can include the sensor of any of the first to fourth embodiments, further comprising a plurality of sensors configured to make measurements used for calculations of a plurality of characteristics of the ambient air.

A sixth embodiment can include the sensor of the fifth embodiment, wherein the plurality of sensors comprises one or more of a temperature sensor, a particulate matter sensor, a humidity sensor, or a gas sensor.

A seventh embodiment can include the sensor of any of the first to sixth embodiments; wherein the processing system is further programmed to wirelessly communicate with one or more devices.

An eighth embodiment can include the sensor of the seventh embodiment, wherein the sensor device is configured to communicate with an HVAC system comprising an air cleaning device.

A ninth embodiment can include the sensor of any of the first to eighth embodiments, wherein the sensor device is configured to wirelessly communicate with an air cleaning device, and configured to activate the air cleaning device in response to the calculated characteristic of the ambient air.

A tenth embodiment can include the sensor of any of the first to ninth embodiments, further comprising an indicator light incorporated into the front surface.

An eleventh embodiment can include the sensor of any of the first to tenth embodiments; wherein the indicator light comprises a ring near the outer edge of the circular front surface.

A twelfth embodiment can include the sensor of any of the first to eleventh embodiments, wherein the sensor device is wall mountable.

In a thirteenth embodiment, a method for determining one or more characteristics of the ambient air of an environment may comprise activating a sensor device comprising one or more sensors and a display; detecting, by the one or more sensors, one or more characteristics of ambient air; displaying, by a processing system via the display, the detected characteristic(s) of the ambient air; and indicating, by the processing system via the display, a health level of the detected characteristic(s).

A fourteenth embodiment can include the method of the thirteenth embodiment, further comprising activating an HVAC system based on the detected characteristic(s) of the ambient air.

A fifteenth embodiment can include the method of the any of the thirteenth to fourteenth embodiments, wherein the sensor comprises a particulate matter sensor, and wherein the method further comprises activating an air cleaning based on the detected particulate matter in the ambient air.

A sixteenth embodiment can include the method of any of the thirteenth to fifteenth embodiments, wherein indicating the health level of the detected characteristic(s) comprises activating a light with a predefined color associated with the health level.

A seventeenth embodiment can include the method of any of the thirteenth to fifteenth embodiments, wherein the sensors detect characteristics of the ambient air around the sensor device.

An eighteenth embodiment can include the method of any of the thirteenth to seventeenth embodiments, wherein the sensor device is configured to wirelessly communicate with one or more remote sensors, wherein the remote sensors may be located on the exterior of an enclosure, while the sensor device is located on the interior of the enclosure.

In a nineteenth embodiment, a sensor device for controlling an HVAC system within an enclosure may comprise a first sensor positioned behind a front surface of the sensor device, configured to make measurements used for a calculation of a characteristic of ambient air within the enclosure; and a wireless communication system having active and inactive states, the system consuming less energy in the inactive state than in the active state, configured to communicate with the HVAC system based on the input from the first sensor, wherein the transition.

A twentieth embodiment can include the sensor device of the nineteenth embodiment, wherein the sensor device is configured to wirelessly communicate with an air cleaning device of the HVAC system, and, when in the active state, is configured to activate the air cleaning device in response to the calculated characteristic of the ambient air.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow, that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any inventions) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A sensor device (100) comprising:
a sensor housing (102) having a circular exterior front surface (104);
a display (130) incorporated into the front surface (104);
a touch sensitive surface (132) incorporated into the front surface (104);
a first sensor (170) positioned behind the front surface (104), configured to make measurements used for a calculation of a characteristic of ambient air;
an angled bottom surface (106) configured to rest on a horizontal surface (112); and
a processing system (160) programmed to detect at least one characteristic of the ambient air, and to display (130) the detected characteristic using the display (130).

2. The sensor device (100) of claim 1, wherein the touch sensitive surface (132) comprises one or more buttons incorporated into the front surface (104).

3. The sensor device (100) of claim 1, wherein the touch sensitive surface (132) comprises at least a portion of the front surface (104).

4. The sensor device (100) of claim 1, wherein the first sensor (170) comprises at least one of a temperature sensor, a particulate matter sensor, a humidity sensor, or a gas sensor.

5. The sensor device (100) of claim 1, further comprising a plurality of sensors (170) configured to make measurements used for calculations of a plurality of characteristics of the ambient air.

6. The sensor device (100) of claim 5, wherein the plurality of sensors (170) comprises one or more of a temperature sensor, a particulate matter sensor, a humidity sensor, or a gas sensor.

7. The sensor device (100) of claim 1, wherein the processing system (160) is further programmed to wirelessly communicate with one or more devices.

8. The sensor device (100) of claim 7, wherein the sensor device (100) is configured to communicate with an MAC system comprising an air cleaning device.

9. The sensor device (100) of claim 1, wherein the sensor device (100) is configured to wirelessly communicate with an air cleaning device, and configured to activate the air cleaning device in response to the calculated characteristic of the ambient air.

10. The sensor device (100) of claim 1, further comprising an indicator light (120) incorporated into the front surface (104).

11. The sensor device (100) of claim 1, wherein the indicator light (120) comprises a ring near the outer edge of the circular front surface (104).

12. The sensor device (100) of claim 1, wherein the sensor device (100) is wall mountable.

13. A method for determining one or more characteristics of the ambient air of an environment, the method comprising:
activating a sensor device comprising one or more sensors and a display;
detecting, by the one or more sensors, one or more characteristics of ambient air;
displaying, by a microprocessor via the display, the detected characteristic(s) of the ambient air; and
indicating, by the microprocessor via the display, a health level of the detected characteristic(s).

14. The method of claim 13, further comprising activating an HVAC system based on the detected characteristic(s) of the ambient air.

15. The method of claim 13, wherein the sensor comprises a particulate matter sensor, and wherein the method further comprises activating an air cleaning system based on the detected particulate matter in the ambient air.
